(19) United States
(12) Patent Application Publication
(10) Pub. No.: US 2017/0178037 A1
(43) Pub. Date: Jun. 22, 2017

(54) Flight Safety Forecasting and Hazard Avoidance

(71) Applicants: Evan John Kaye, Short Hills, NJ (US); David Seth Leibowitz, Short Hills, NJ (US)

(72) Inventors: Evan John Kaye, Short Hills, NJ (US); David Seth Leibowitz, Short Hills, NJ (US)

(21) Appl. No.: 14/970,754

(22) Filed: Dec. 16, 2015

(51) Int. Cl. G06Q 10/04; G06Q 10/02

(52) U.S. Cl. CPC G06Q 10/047; G06Q 10/02

(57) ABSTRACT

The invention relates to an air travel scheduling platform that incorporates turbulence forecast and other safety data into search results and flight query filters such that air travelers can choose flight options that minimize their risk of experiencing turbulence, or exposure to other hazardous events. It also allows travelers to monitor turbulence and other hazardous forecasts for specified flights.

### CROSS-REFERENCE TO RELATED APPLICATION

This application claims the benefit of U.S. Provisional Application No. 62092311 filed on Dec. 16, 2014.

### FIELD OF THE INVENTION

The invention relates to an air travel scheduling platform that incorporates turbulence forecast and other safety data into search results and flight query filters such that air travelers can choose flight options that minimize their risk of experiencing turbulence, or exposure to other hazardous events. It also allows travelers to monitor turbulence and other hazardous forecasts for specified flights.

### BACKGROUND OF THE INVENTION

Turbulence is a natural phenomenon created by atmospheric pressure—chaotic, irregular motion of air like a rodeo bronco or pogo stick. For many fliers, encountering air turbulence is the most challenging and unnerving aspect of air travel. It arrives without warning. The effects of turbulence, which can cause an aircraft to shake and move suddenly and erratically from side to side or up and down, can be distressing and even frightening, sparking fear that the airplane is out of control and about to crash or break apart. From inside an airplane, it can range from minor bumpiness that can jostle the beverage on your tray table to powerful jolts that can structurally damage the plane and injure its passengers. According to the Federal Aviation Administration, turbulence is the number one cause of in-flight injuries to airline passengers and flight attendants in nonfatal accidents; often suffering bruises and broken bones. In the United States each year, pilots report about 65,000 accounts of moderate or greater turbulence and 5,500 accounts of severe turbulence. Turbulence is responsible for roughly 75% of all aviation weather-related accidents and incidents causing tens of millions of dollars in annual injury claims, according to the National Transportation Safety Board. Global changes in climate are expected to result in bumpier flights and scientists conclude that air turbulence is increasing. The damage to airplanes might be low but the damage to people is high. Despite placating statements, turbulence can rattle even the most well-adjusted experienced fliers because of our lack of control and limited understanding of atmospheric conditions and airplane mechanics. There is a large population of anxious fliers or people with a phobia to fly and everybody responds to flying differently.

There are several things to guard against the effects of turbulence. While wearing your seat belt during the entire flight is the most important, you can also choose flights that are likely to encounter less turbulence. For example, in the summer, the sun heats the earth's surface unevenly, often producing more turbulent air. If you choose to fly early in the day in summer, you're more likely to have a smoother flight. Fliers who are especially bothered by turbulence choose a seat over the wings of the aircraft, which puts them close to the center of mass and reduces the effects of turbulence.

Some geographic regions have better weather forecasting infrastructure than others, and some aircraft are outfitted with cockpit weather information systems that have superior capabilities to others. There are many variables that have to be taken into account in forecasting and avoiding turbulence, including: (1) weather forecasts; (2) aircraft factors such as onboard sensors, turbulence decision aids, user interface, presentation of data, size and type of aircraft; (3) route factors such as typical traffic, terrain, typical flight plan, obstacles, special use airspace, ground and satellite coverage; (4) human factors such as pilot experience and airline training. Taking all these factors into account it is possible to predict with some degree of certainty what the probability is of turbulence, and how severe the turbulence might be.

There are other hazardous conditions related to travel, including exposure to communicable diseases. During the flu season, for instance, a passenger may be more readily exposed to the virus if they travel to, or connects through an airport that is located in a region that typically has many flu cases that time of year. However, there is currently no way to account for this when planning a flight that may connect through such a high risk region. When someone connects in an airport in a region with many cases of the flu, they may be exposed in the airport where local people are also stationed, as well as on the plane where locals will also be travelling. Furthermore, taking two flights may increase the statistical risk to them of contracting the flu given increased exposure to others on the flight. It may be preferred to choose a flight that is less crowded too. There may also be current epidemics, such as Ebola where people prefer to avoid certain countries, but there is currently no warning system or indicators on travel reservation systems to help people with such requests.

### SUMMARY OF THE INVENTION

Oftentimes there will be a number of options to the traveler regarding the type of aircraft, day of travel, connection airports, and more. For these reasons, one aspect of this invention that would be comforting to the traveler to assist in their decision making is a platform which does some or all of the following: (1) compiles a database (aggregating/storing/pooling information neatly into search fields) distinguishing type of aircraft, history of previous routes flown/flight-paths, average altitude flown, average flight time, FAA complaints/incident reports, seat location on aircraft, historical weather patterns, and future weather forecasts for each route flown; (2) allows a user to search, sort and filter for flights which take into account turbulence risk, or other risks; (3) present flight options to the user a custom and unique output for them to make and monitor more informed flight reservation decisions; (4) monitor a flight as departure time approaches and update a user with more refined turbulence, or other risk, predictions.

Since specific seat position on certain aircrafts may be more or less favorable during turbulence, the availability of specific seats could also affect the turbulence risk for available seats on that flight. The turbulence risk comprises two components: the probability of turbulence and the intensity of the turbulence forecasted. These may be combined into a single score giving certain weights to each factor, and could also have certain threshold limits to each factor before they contribute to the combined score (for instance, low turbulence intensity may be ignored even if there is a high probability of it occurring).

In another aspect of this invention a more general risk score can also be presented to the user, and may include statistics about major fatalities by an airline, or type of aircraft. The two scores, turbulence risk and fatality risk may be combined into a single hazard score and presented to the user (also allowing the user to query only certain flights that meet a minimum threshold for the score, or sort flight results by the hazard score).

Also certain air space regions may be in close proximity to areas of political unrest and conflict such that a civil airplane would be at increased risk flying near the region due to either intentional or unintentional interception of some form of surface-to-air or air-to-air weapon. Tracking, indicating and using such information about worldwide events would be useful in allowing someone to choose a flight path, or airline connections, with a lower risk. Some airports may also be in regions that are at a higher risk of some form of terror or other attack, and therefore may be avoided by the traveller. Another factor to consider is the track record and thoroughness of security procedures at each airport. By avoiding those airports, or countries, with suboptimal procedures, a traveller is decreasing their risk for the journey.

Another factor to consider is the age of the equipment, the type of equipment and track record of the manufacturer. Any current recalls, and the history and maintenance track record of the airline. By considering all such factors, a comprehensive hazard score can be given to the overall risk associated with each flight choice and path.

### DESCRIPTION OF THE FIGURES

FIG. 1 shows a web-based flight search results page with incorporated turbulence forecast information; and

FIG. 2 shows a calendar flight planner which with incorporated turbulence information.

### DETAILED DESCRIPTION OF THE PREFERRED EMBODIMENT

The invention is described in detail with particular reference to a certain preferred embodiment, but within the spirit and scope of the invention, it is not limited to such an embodiment. It will be apparent to those of skill in the art that various features, variations, and modifications can be included or excluded, within the limits defined by the claims and the requirements of a particular use.

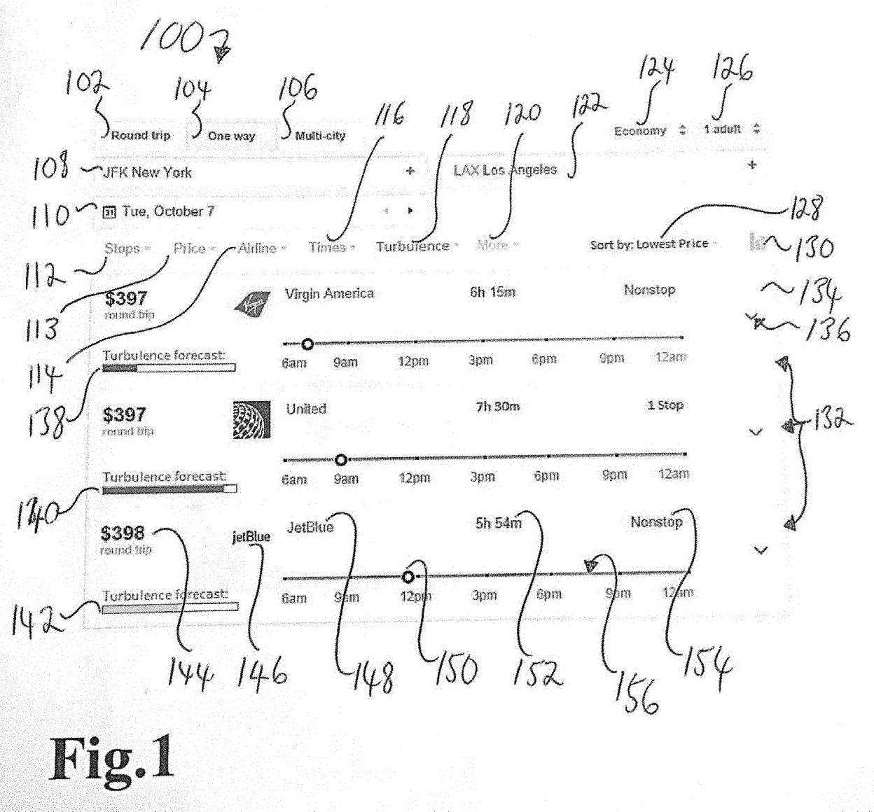

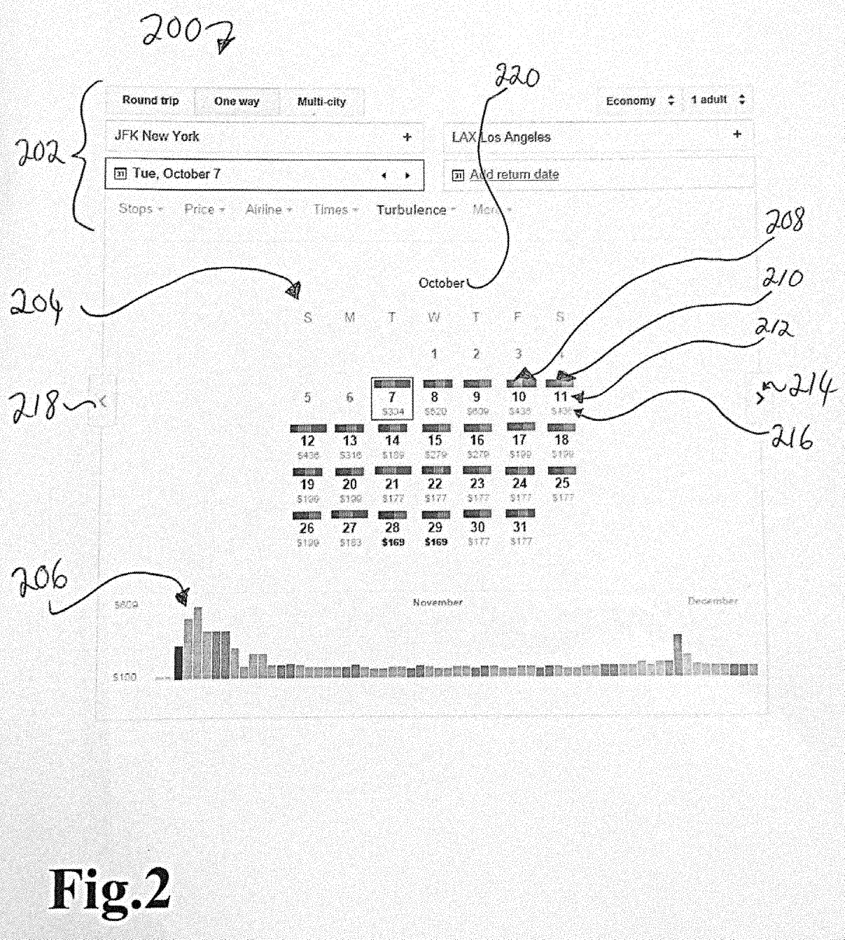

One embodiment of the invention is for an airline reservation system that is web based. It is best described by way of the accompanying figures. With reference now to FIG. 1 a web-based flight search results page 100 with incorporated turbulence forecast information is shown. The search results page 100 has three tabs which are for Round Trip 102, One Way 104, and Multi-City 106 searches respectively. On the search results page 100 shown, the One Way 104 tab is highlighted indicating that the user has selected to search for a single trip from the airport in the Origin field 108 to the airport in the Destination field 122. A class dropdown selector 124 and number of travelers dropdown selector 126 specify the respective class and number of seats as additional search parameters. The user specifies the desired date of travel in the date field 110. There are also a number of facets that can be modified by the user: stops 112, price 113, airline 114, times 116, turbulence 118, and a dropdown selector for more facets 120. These facets dynamically update with the search results to that the user can refine the search as is conventionally done in advanced searches that give the user control over many filters. The turbulence facet 118 is one aspect of this invention and allows a user to filter results based on the degree of turbulence forecasted. For instance, they may only want to see flights that are predicted to have a low degree of turbulence. The Sort by facet 128 shows that the search results are sorted ascending from Lowest Price. Other sort options might include to sort ascending from Lowest Turbulence forecasted, or by number of stops. The graph button 130 allows a user to switch to the graph and calendar view 200 of FIG. 2 where they can appreciate the price distribution on various days as well as the turbulence predicted on various days as described in more detail below. The flight search results 132 shows three flight matches for the search parameters. Each result has a price 144, airline logo 146, airline name 148, departure time illustration 150 on the timeline 156, flight duration 156, and the number of stops 154. Each result also has a turbulence forecast, which is a low forecast 138 for the first result 134, a high forecast 140 for the second result, and a medium forecast 142 for the last result. The graphical representation of the turbulence forecast gives the user an easy way to appreciate the synthesis of many inputs in which the turbulence forecast is derived. Such inputs may have included: (1) weather forecasts for each leg; (2) aircraft factors for each leg of the proposed flight in the search result, such as onboard sensors, turbulence decision aids, user interface, presentation of data, size and type of aircraft; (3) route factors such as typical traffic, terrain, typical flight plan, obstacles, special use airspace, ground and satellite coverage for each leg; (4) human factors such as pilot experience and airline training for each leg; (5) seat availability for the leg of each flight for optimum placement in the event of turbulence. When the user is ready to select a flight, they can select it using the selector 136 which would give more details about the proposed flight route and allow them to proceed to book it either on the same website, or refer them to the airline or other booking site to complete the booking.

With reference now to FIG. 2 a calendar flight planner view 200 is shown which incorporates turbulence information. The top section 202 is identical to the flight search results page 100 of FIG. 1. Below the top section 202 is a calendar 204 for the month labelled October 220. The left arrow button 218 and right arrow button 214 allows the user to change month backward and forward respectively. The price distribution graph 206 shows the lowest price flight for any given day in the calendar. A turbulence forecast indicator 208 is present for all days where flights are available. It proportionally represents the number of flights with low, medium and high turbulence risk scores. The turbulence risk score comprises the probability and intensity of turbulence as described above. If there are no flights with a high turbulence risk score on a particular day then a two-color turbulence forecast indicator 210 is shown. The calendar day 212 is shown along with the lowest flight price 216 for each day.

Another aspect of this invention is guiding the traveler to choose the seats on the aircraft that are most optimal during turbulence. While the invention may be embodied in a flight search engine that is separate from the seat selection platform (as this is typically hosted on the airline site), guidance to the user can still be given by way of a seat map that shows, for instance, green, yellow and red areas, where green are the preferred seats when there is turbulence, red being the worst seats to be in when there is turbulence, and yellow would be in between. Full integration into the seat selection platform would be ideal, as the airline would be able to offer this guidance on the same screen as the seat selection is made.

The data regarding forecast and current incidence of specific communicable diseases is increasingly becoming more readily available. The Center of Disease Control publishes data, as well as travel advisories, and there is also data that can be gathered in real time from electronic medical record systems, pharmacy fulfillments, and other sources. The search engine could take into account these disease patterns in issuing alerts and recommendations on travelling through regions that are less likely to result in exposure to the infectious agent. For instance, for someone travelling from New York to Los Angeles, they may have the option of direct flights, in addition to cheaper flights that connect in Chicago in the winter. Forecasts may show that there is a high incidence of flu in the Chicago area during the travel time and show such data in the flight search results, in a way similar to the turbulence risk, so that the traveler can make an informed decision about which flight they should choose.

We claim:

1. An air travel scheduling platform comprising:
flight options with times and connections and routes; and
risk scores associated with the safety related to each flight option.

2. The air travel scheduling platform of claim 1, wherein the risk scores incorporate weather factors.

3. The air travel scheduling platform of claim 1, wherein the risk scores incorporate communicable disease data.

4. The air travel scheduling platform of claim 1, wherein the risk scores incorporate proximity to areas of conflict.

5. The air travel scheduling platform of claim 1, wherein the risk scores incorporate proximity to areas of conflict.

6. The air travel scheduling platform of claim 1, wherein the risk scores incorporate safety record of flight equipment to be used.

7. The air travel scheduling platform of claim 1, wherein the risk scores incorporate safety records of airlines.

8. The air travel scheduling platform of claim 1, wherein the risk scores incorporate maintenance track records of the airlines.

9. The air travel scheduling platform of claim 1, wherein the risk scores incorporate security factors relating to airports that will be used for each flight route.

10. A method of decreasing air travel risk by feeding data relating to a plurality of factors into a platform and displaying in aggregate the risk scores associated with specific flight options to a user who is then in a more informed position to choose a lowest risk flight schedule.

11. The method of claim 10, wherein the data relating to a plurality of factors include weather factors.

12. The method of claim 10, wherein the data relating to a plurality of factors include communicable disease data.

13. The method of claim 10, wherein the data relating to a plurality of factors include proximity to areas of conflict.

14. The method of claim 10, wherein the data relating to a plurality of factors include the safety record of flight equipment to be used.

15. The method of claim 10, wherein the data relating to a plurality of factors include the safety records of airlines.

16. The method of claim 10, wherein the data relating to a plurality of factors include the maintenance track records of the airlines.

17. The method of claim 10, wherein the data relating to a plurality of factors include security factors relating to airports that will be used for each flight route.
